(19) United States
(12) Patent Application Publication
(10) Pub. No.: US 2013/0091832 A1
(43) Pub. Date: Apr. 18, 2013

(54) REINFORCED V-BAND CLAMP

(71) Applicants: Marc L. Friedrich, Rochester Hills, MI (US); Gary Clark, II, Sterling Heights, MI (US)

(72) Inventors: Marc L. Friedrich, Rochester Hills, MI (US); Gary Clark, II, Sterling Heights, MI (US)

(73) Assignee: GM GLOBAL TECHNOLOGY OPERATIONS LLC, Detroit, MI (US)

(21) Appl. No.: 13/272,429

(22) Filed: Oct. 13, 2011

(51) Int. Cl. F01N 13/10; F16L 23/04

(52) U.S. Cl. 60/323; 285/421

(57) ABSTRACT

A clamp includes a curved band having an inner surface, an outer surface, a first end, and a second end. The band is characterized by a substantially V-shaped cross-section in a radial plane of the band. The inner surface of the band defines the inside contour of the V-shaped cross-section. The clamp also includes a fastener configured to draw together the first and second ends such that the band may be tightened around adjacent flanges of objects to be clamped together. The inner surface is configured to squeeze the flanges together and clamp the objects. The band includes a reinforcement configured to stiffen the substantially V-shaped cross-section and minimize yielding of the cross-section when the objects are being clamped. An engine assembly that includes a first exhaust component and a second exhaust component having respective first and second flanges being squeezed and clamped together via the clamp is also disclosed.

### TECHNICAL FIELD

The present disclosure is drawn to a reinforced V-band clamp.

### BACKGROUND

A fastener is a hardware device that mechanically affixes or joins two or more objects. A majority of fastening devices have the capability to be selectively secured and removed on demand. Such removable fastening devices replace other, generally more permanent methods of joining materials, such as crimping, welding, and use of various adhesives.

A clamp is a type of a fastening device used to secure tightly or hold together objects to prevent their relative movement or separation through an application of inward pressure at the objects' interface. Depending on the clamp's actual construction, the clamp may be a non-reusable type of a fastening device or configured to be fastened, removed, and then refastened on demand.

A band clamp, also known as a web clamp, is a type of a clamp which allows the clamping of objects whose surfaces needing to be clamped are not parallel to each other, where there are multiple surfaces involved, or where clamping pressure is simultaneously required from multiple directions. The clamping pressure is generally applied either through a mechanical method, such as a screw or ratchet mechanism which tightens the band, or through an elastic nature of the band material itself.

A V-band clamp is a type of a band clamp that is characterized by an angled or “V” shaped cross-section of its band. The band's V-shaped cross-section is used to squeeze complementary angled flanges of the objects sought to be clamped in order to draw in and press the subject flanges together.

### SUMMARY

A clamp includes a curved band having an inner surface, an outer surface, a first end, and a second end. The band is characterized by a substantially V-shaped cross-section located in a radial plane of the band. The inner surface of the band defines the inside contour of the V-shaped cross-section. The clamp also includes a fastener configured to draw together the first and second ends such that the band may be tightened around adjacent flanges of objects sought to be clamped together. The inner surface is configured to press or squeeze the flanges together and clamp the objects. The band includes a reinforcement configured to stiffen the substantially V-shaped cross-section and minimize yielding of the cross-section when the objects are being clamped.

The substantially V-shaped cross-section may be defined by a first portion, a second portion, and an interface joining the first and second portions. In such a case, the reinforcement may be arranged at the interface.

The reinforcement may be at least one localized formed depression projecting from the inner surface. Furthermore, the at least one localized formed depression may be a plurality of depressions staggered along the band.

The reinforcement may be at least one radial rib projecting from the outer surface. The at least one radial rib may extend continuously over the first portion, the second portion, and the interface.

The at least one radial rib may be formed on the band. The at least one radial rib may also be affixed to the band. Furthermore, the at least one radial rib may be a plurality of ribs arranged along the band.

The band may include a plurality of curved segments linked by a hinge. Additionally, the band may be formed from stainless steel.

An engine assembly that includes a first exhaust component and a second exhaust component having respective first and second flanges being squeezed and clamped together via the clamp is also disclosed.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a perspective view of an internal combustion engine operatively connected to an exhaust system, wherein the exhaust system employs a plurality of reinforced clamps to affect connections between the system's components, wherein a fragmented view of the clamps is shown for illustration of fastened features.

FIG. 2 is a close-up perspective view of one of the clamps shown in FIG. 1.

FIG. 3 is an illustration of a cross-section of the clamp shown in FIG. 2, depicting an embodiment of clamp reinforcement.

FIG. 4 is a schematic perspective sectional view of the clamp having an alternative embodiment of the reinforcement located on the clamp shown in FIG. 2.

FIG. 5 is a schematic perspective sectional view of the clamp having another alternative embodiment of the reinforcement located on the clamp shown in FIG. 2.

FIG. 6 is a schematic perspective sectional view of the clamp having one of the reinforcements shown in FIG. 3.

### DETAILED DESCRIPTION

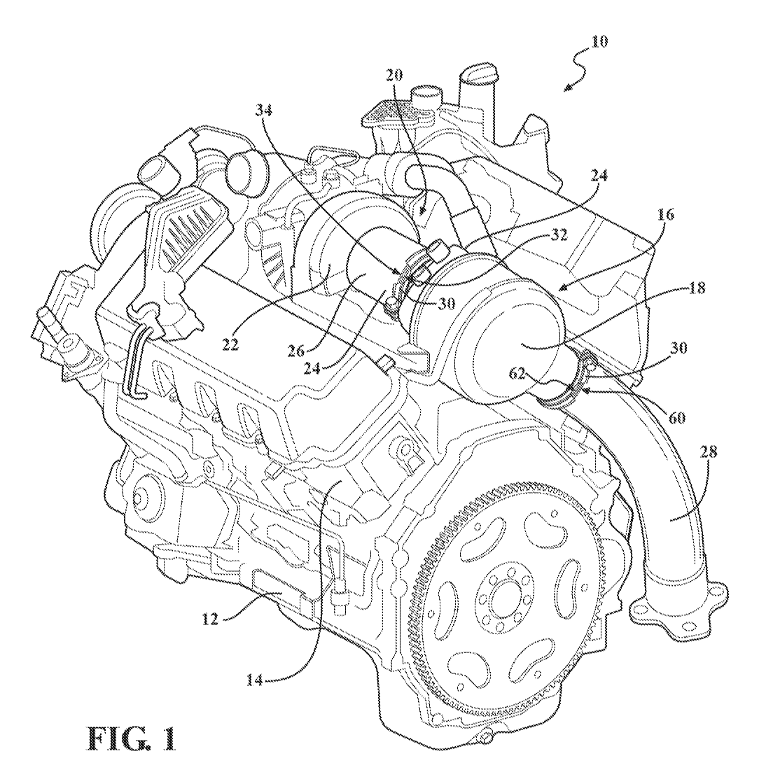

Referring to the drawings, wherein like reference numbers refer to like components, FIG. 1 shows a perspective schematic view of an internal combustion engine 10. The engine 10 includes a cylinder block 12 and cylinder heads 14 that are mounted on the cylinder block 12. Although not shown in the provided figures, the cylinder block 12 and cylinder heads 14 enclose cylinders that house reciprocating pistons, which are in turn operatively connected to an engine crankshaft.

The cylinders of the engine 10 typically receive a mixture of fuel and air to generate combustion and produce engine output torque at the crankshaft via the reciprocation of the pistons. Following combustion of the fuel-air mixture inside the cylinders, the post-combustion gasses are passed to the atmosphere through dedicated exhaust system 16 having an exhaust gas catalyst 18. As known by those skilled in the art, exhaust gas catalysts are typically configured to oxidize and burn hydrocarbon emissions present in the exhaust flow. Although the engine 10 is illustrated as a compression-ignition type, a spark-ignition type of an engine is similarly envisioned.

The exhaust system 16 also includes an exhaust-gas driven turbocharger 20. The turbocharger 20 is configured to pressurize the incoming air flow via a compressor wheel (not shown) that is housed inside a compressor housing 22. The pressurized airflow is subsequently used in combination with a proportionately supplied amount of fuel for combustion to thereby enhance torque output and volumetric efficiency of the engine 10. The turbocharger 20 also includes a turbine wheel (not shown) that is housed inside a turbine housing 24. The turbine wheel is mounted on a common shaft (not shown) with the compressor wheel. The shaft is rotatably supported inside a bearing housing 26. The turbine housing 24 is attached to the cylinder heads 14 for receiving the exhaust gas flow from the engine cylinders. As the turbine wheel is energized by the exhaust gas flow being released by engine 10 following each combustion event, the turbine wheel transmits rotational motion to the compressor wheel for pressurizing the incoming air flow.

As shown in FIG. 1, the turbocharger 20 is close-coupled via the turbine housing 24 to the cylinder heads 14 and the catalyst 18 is close-coupled to the turbocharger. Such close-coupling of the exhaust components to the cylinder heads 14 reduces exhaust heat loss, which in turn serves to lessen the time required to light off the catalyst after the engine is initially started. The exhaust system 16 also includes a downpipe 28 which is coupled to the catalyst 18 and is configured to channel the exhaust gas to the remaining exhaust plumbing (not shown) and eventually out to the atmosphere. Accordingly, the catalyst 18, the turbine housing 24, the bearing housing 26, and the downpipe 28 are all exposed to elevated heat of the post-combustion exhaust gases.

As is known by those skilled in the art, the temperature of post-combustion exhaust gases may exceed 1,600 degrees Fahrenheit in compression-ignition engines, and may exceed 1,900 degrees Fahrenheit in spark-ignition types. Additionally, the respective interfaces between the turbine housing 24, the bearing housing 26, the catalyst 18, and the downpipe 28 are generally sought to be substantially sealed such that any exhaust gas leakage therethrough is minimized. Accordingly, matched interface surfaces, as well as robust fasteners, such as clamps and screws, capable of withstanding elevated temperatures are typically required.

The turbine housing 24 is coupled to the bearing housing 26 via a clamp 30. The turbine housing 24 includes a fastening flange 32 and the bearing housing 26 includes a complementary fastening flange 34, wherein the flanges are engaged and drawn together by the clamp 30. Each of the flanges 32 and 34 is characterized by an angled surface, 33 and 35 respectively (shown in FIG. 3). The angled surfaces 33, 35 are characterized by a generally smooth finish to permit the clamp 30 to slide relative to the surfaces as the clamp is tightened, i.e., drawn radially inward, during assembly. Accordingly, the angled surfaces 33, 35 are engaged by the clamp 30 and facilitate the flanges being drawn together as the clamp is tightened.

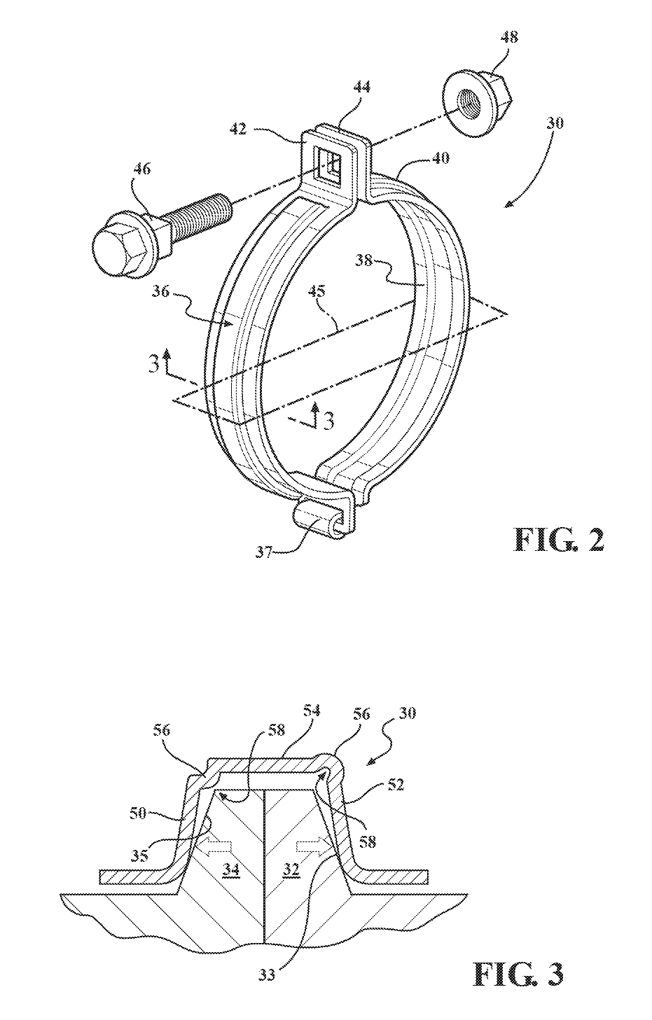

As shown in FIG. 2, the clamp 30 includes a body that is configured as a curved band 36. In order to durably withstand elevated temperatures of the exhaust system 16, the band 36 may be formed from a temperature resistant material such as stainless steel. Furthermore, the band 36 may be a continuous element or be composed from a plurality of curved segments linked by a hinge 37. The band 36 includes an inner surface 38, an outer surface 40, a first end 42, and a second end 44. The band 36 is characterized by a substantially V-shaped cross-section 3-3 located in a radial plane 45 of the band (shown in FIG. 2). Accordingly, the clamp 30 is commonly known as a V-band clamp. As will be described in greater detail below, although the cross-section 3-3 is substantially V-shaped, the cross-section may also include a largely flat interface portion that connects the two sides of the “V”. The inner surface 38 of the clamp 30 defines the inside contour of the V-shape. The clamp 30 also includes a fastener that includes a screw 46 and a nut 48. Similar to the band 36, both the screw 46 and the nut 48 may formed from a temperature resistant material such as stainless steel. As the turbine housing 24 and the bearing housing 26 are being clamped together, the screw 46 and nut 48 combine to clench, i.e., draw together, the first and second ends 42, 44 such that the band 36 is tightened around the flanges 32, 34. Accordingly, as the clamp 30 is tightened, the inner surface 38 squeezes or presses the flanges 32 and 34 together and substantially seals the interface between the flanges to minimize exhaust gas leakage.

As shown in FIG. 3, the cross-section 3-3 is defined by a first portion 50, a second portion 52, and an interface 54, that is shown as a largely flat portion, joining the first and second portions. As shown in FIGS. 2-6, the band 36 additionally includes at least one reinforcement 56. The reinforcement 56 is configured to stiffen the cross-section 3-3 and minimize yielding of the cross-section when the turbine housing 24 and the bearing housing 26 are being clamped. The reinforcement 56 is arranged at the interface 54. As shown in FIGS. 3 and 6, the reinforcement 56 may be configured as a localized formed depression projecting outwardly from the inner surface 38. The reinforcement 56 may also be configured as a localized formed depression projecting outwardly from the outer surface 40 (shown in FIG. 3). As shown, each localized formed depression is positioned substantially in a corner transition 58 between the interface 54 and one of the first and second portions 50, 52. A plurality of such localized formed depressions may be staggered along the band 36. Such positioning of the localized formed depression reinforcement 56 substantially stiffens the cross-section 3-3 and, accordingly, the structure of the clamp 30.

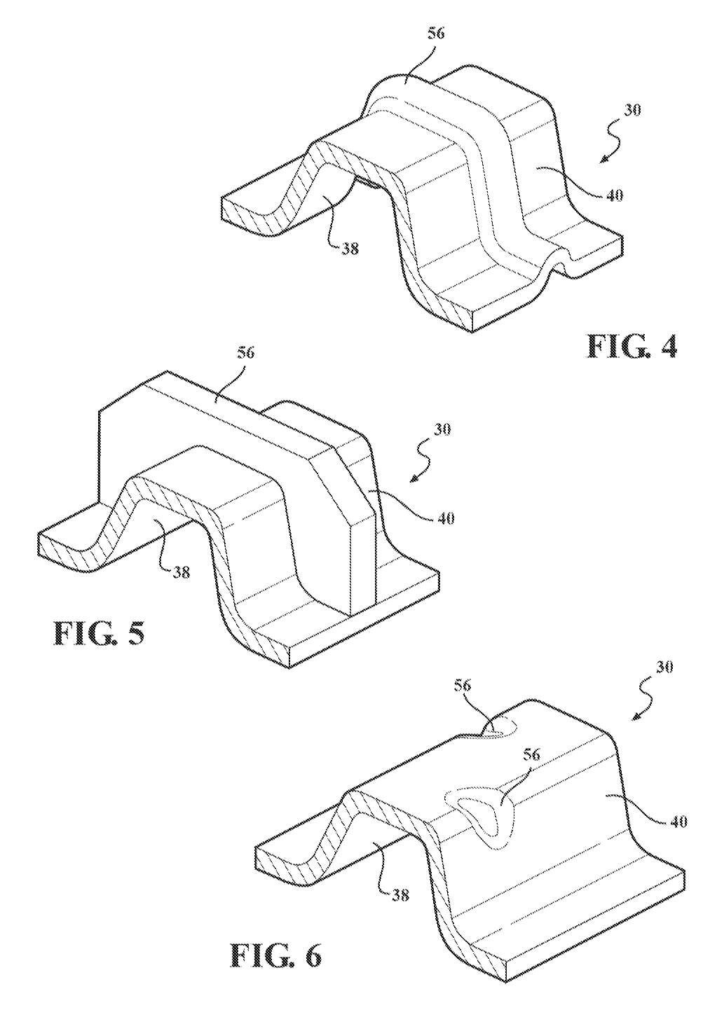

As shown in FIG. 4, the reinforcement 56 may also be configured as a radial formed rib projecting outwardly from the outer surface 40. As shown in FIG. 5, the reinforcement 56 may similarly be configured as a radial rib that is affixed to the outer surface 40, such as by a process of welding. As shown, the rib may extend continuously over the first portion 50, the second portion 52, and the interface 54. The rib reinforcements 56 are positioned to substantially stiffen the corner transitions 58 between the interface 54 and the first and second portions 50, 52. A plurality of such ribs may be staggered along the band 36. As with the localized formed depressions described above, such positioning of the rib reinforcements 56 substantially stiffens the cross-section 3-3 and, accordingly, the structure of the clamp 30.

Other interfaces on the exhaust system 16 may also be joined via the same type of clamp 30. As shown in FIG. 1, the catalyst 18 may be coupled to the downpipe 28 via clamp 30. Accordingly, the downpipe 28 includes a fastening flange 60 and the catalyst 18 includes a complementary fastening flange 62 that are engaged and drawn together by the respective clamp 30. Similar to surfaces 33 and 35 shown in FIG. 3, each of the flanges 60 and 62 is characterized by an angled surface having a generally smooth finish. The angled surfaces of the flanges 60 and 62 are engaged by the clamp 30 and are drawn together as the clamp is tightened.

Additionally, although not depicted in the Figures, the turbine housing 24 may also be coupled to the catalyst 18 turbine housing 24 via clamp 30. Accordingly, the downpipe 28 would include a fastening flange and the catalyst 18 includes a complementary fastening flange that would be engaged and drawn together by the respective clamp 30. Similar to surfaces 33 and 35 shown in FIG. 3 and the surfaces of the fastening flanges 60 and 62, each of the flanges in such a case would be characterized by an angled surface having a generally smooth finish for being engaged by the clamp 30 in order to be drawn together as the clamp is tightened.

Generally, the fastening or clamping pressure from the clamp 30 is applied from two opposing sides of a particular joint between two objects, at an angle towards the center of the band 36 to thereby squeeze the mating flanges together as the clamp is tightened. Such clamping pressure tends to spread the first portion 50 and the second portion 52 apart. When combined with elevated heat of the exhaust system 16 during operation of the engine 10, over time the clamping pressure is particularly likely to permanently yield the cross-section 3-3 at the corner transitions 58. Such yielding of the cross-section 3-3 will permit the joint between the objects to eventually loosen and an exhaust gas leak to develop. The addition of reinforcements 56 to the band 36 are intended to counteract the clamping pressure and reduce the likelihood of the cross-section 3-3 yielding, thus minimizing the possibility of an exhaust gas leak through the respective joint.

While the best modes for carrying out the invention have been described in detail, those familiar with the art to which this invention relates will recognize various alternative designs and embodiments for practicing the invention within the scope of the appended claims.

1. A clamp comprising:
a curved band having an inner surface, an outer surface, a first end, and a second end, wherein the band is characterized by a substantially V-shaped cross-section located in a radial plane of the band and the inner surface defines the inside contour of the substantially V-shaped cross-section; and
a fastener configured to draw together the first and second ends such that the band may be tightened around adjacent flanges of objects sought to be clamped together, wherein the inner surface of the band is configured to squeeze the flanges together and clamp the objects;
wherein the band includes a reinforcement configured to stiffen the substantially V-shaped cross-section and minimize yielding of the cross-section when the objects are being clamped.

2. The clamp of claim 1, wherein:
the substantially V-shaped cross-section is defined by a first portion, a second portion, and an interface joining the first and second portions; and
the reinforcement is arranged at the interface.

3. The clamp of claim 2, wherein the reinforcement is at least one localized formed depression projecting from the inner surface.

4. The clamp of claim 3, wherein the at least one localized formed depression is a plurality of depressions staggered along the band.

5. The clamp of claim 2, wherein the reinforcement is at least one radial rib projecting from the outer surface.

6. The clamp of claim 5, wherein the at least one radial rib extends continuously over the first portion, the second portion, and the interface.

7. The clamp of claim 5, wherein the at least one radial rib is formed on the band.

8. The clamp of claim 5, wherein the at least one radial rib is affixed to the band.

9. The clamp of claim 5, wherein the at least one radial rib is a plurality of ribs arranged along the band.

10. The clamp of claim 1, wherein the band includes a plurality of curved segments linked by a hinge.

11. An engine assembly comprising:
a cylinder head:
a first exhaust component having a first flange, wherein the first exhaust component is operatively connected to the cylinder head:
a second exhaust component having a second flange; and
a clamp configured to fasten the first flange to the second flange such that the first exhaust component is clamped to the second exhaust component, wherein the clamp includes:
a curved band having an inner surface, an outer surface, a first end, and a second end, wherein the band is characterized by a substantially V-shaped cross-section located in a radial plane of the band and the inner surface defines the inside contour of the substantially V-shaped cross-section; and
a fastener configured to draw together the first and second ends such that the band may be tightened around the first and second flanges, wherein the inner surface of the band is configured to squeeze the first and second flanges together;
wherein the band includes a reinforcement configured to stiffen the substantially V-shaped cross-section and minimize yielding of the cross-section when the first and second flanges are being squeezed together.

12. The engine assembly of claim 11, wherein:
the substantially V-shaped cross-section is defined by a first portion, a second portion, and an interface joining the first and second portions; and
the reinforcement is arranged at the interface.

13. The engine assembly of claim 12, wherein the reinforcement is at least one localized formed depression projecting from the inner surface.

14. The engine assembly of claim 13, wherein the at least one localized formed depression is a plurality of depressions staggered along the band.

15. The engine assembly of claim 12, wherein the reinforcement is at least one radial rib projecting from the outer surface.

16. The engine assembly of claim 15, wherein the at least one radial rib extends continuously over the first portion, the second portion, and the interface.

17. The engine assembly of claim 15, wherein the at least one radial rib is formed on the band.

18. The engine assembly of claim 15, wherein the at least one radial rib is affixed to the band.

19. The engine assembly of claim 15, wherein the at least one radial rib is a plurality of ribs arranged along the band.

20. The engine assembly of claim 11, wherein the band includes a plurality of curved segments linked by a hinge.
